(19) United States
(12) Patent Application Publication
(10) Pub. No.: US 2003/0156345 A1
(43) Pub. Date: Aug. 21, 2003

(54) Data storage device and method for spindle power control

(76) Inventors: Serge J. Fayeulle, Longmont, CO (US); Paul W. Smith, Niwot, CO (US)

Correspondence Address: Deirdre Megley Kvale, Westman, Champlin & Kelly, International Center, Suite 1600, 900 Second Avenue South, Minneapolis, MN, 55402-3319, US

(21) Appl. No.: 10/185,238

(22) Filed: Jun. 27, 2002

Related U.S. Application Data
(60) Provisional application No. 60/358,154, filed on Feb. 20, 2002.

(51) Int. Cl. G11B 15/46; G11B 21/02; G11B 5/596

(52) U.S. Cl. 360/73.03; 360/75; 360/78.04

(57) ABSTRACT

A data storage device including spindle power control to reduce power consumption. The spindle power control includes a read-write control mode and an idle control mode. In the read-write control mode, the spindle motor is energized to rotate a disc at a fill operating speed for read-write operations and in the idle control mode, spindle speed is reduced to provide an idle power mode. The idle power mode provides a desired or steady state fly height spindle speed so that the head glides above the disc surface during an idle period to reduce power consumption. In illustrated embodiments, the disc includes a dedicated glide zone and the head is positioned in the dedicated glide zone during the idle power mode.

### CROSS-REFERENCE TO RELATED APPLICATION

This application claims priority from U.S. Provisional Application Serial No. 60/358,154 filed on Feb. 20, 2002 and entitled “NEW POWER MANAGEMENT FOR A CSS DRIVE”.

### FIELD OF THE INVENTION

The present invention relates generally to a data storage device and more particularly but not by limitation to a power management system for a data storage device.

### BACKGROUND OF THE INVENTION

Data storage devices store digital information on a rotating disc. The device includes a head having at least one transducer element to read data from or write data to the disc surface. Heads are coupled to an actuator assembly which is energized to position heads for read-write operation. Discs are coupled to a spindle motor which is energized to rotate the discs for operation. Data storage devices can be powered by a line voltage or a portable or battery power source. Portable computers and devices include multiple power modes and can be plugged into a line voltage or can operate on a battery power source. Operating power requirements can limit or reduce operating time or performance for battery powered operation or modes.

During an idle period or interruption in read-write activity, the spindle motor can be powered off to reduce power consumption. However, to restart operation, the spindle motor has to “spin-up” which requires a large power consumption and slows seek or operation following the interruption since the device has to wait for the spindle motor to reach an operating speed before the read/write command can be executed. The process of powering down a spindle motor during an idle period or interruption in read-write activity to reduce power consumption increases contact frequency for contact starts and stops (CSS) increasing wear on the head and increases ramp wear for a ramp load/unload device.

Proximity or near proximity recording heads include an air bearing slider. Rotation of the disc creates an air flow along the air bearing slider to create a hydrodynamic lifting force to define, in part, a fly height for the slider. Prior to operation, the slider is supported on the disc surface for CSS and the slider is supported on a ramp for a ramp load/unload device. For “spin-up” for CSS, sufficient power must be supplied to overcome a stiction force holding the slider to the disc surface increasing seek or response following an idle period or interruption. For a ramp load/unload system, the spindle motor must be powered to provide sufficient air flow to the air bearing slider before the head is released from the load/unload ramp.

Rotating the disc at a lower spindle speed can reduce power requirements during an idle period however, for proximity or near proximity recording fluctuations of the fly height below a glide avalanche height of the disc increases head disc contact increasing wear or damage to the head and disc. For a ramp load/unload device, interruptions in the spindle speed can delay response while the spindle speed of the disc is increased and the head is released from the load/unload ramp. Embodiments of the present invention provide solutions to these and other problems, and offer other advantages over the prior art.

### SUMMARY OF THE INVENTION

The present invention relates to a data storage device including spindle power control to reduce power consumption. The spindle power control includes a read-write control mode and an idle control mode. In the read-write control mode, the spindle motor is energized to rotate a disc at a full operating speed for read-write operations and in the idle control mode, spindle rotation is reduced to provide an idle power mode having a lower spindle rotation speed. The idle control mode provides a desired or steady state fly height spindle speed so that the head glides above the disc surface during an idle period or interruption in read-write activity to reduce power consumption. In illustrated embodiments, the disc includes a dedicated glide zone and the head is positioned in the dedicated glide zone during the idle power mode. Other features and benefits that characterize embodiments of the present invention will be apparent upon reading the following detailed description and review of the associated drawings.

### BRIEF DESCRIPTION OF THE DRAWINGS

FIG. 1 is a diagrammatic illustration of an embodiment of a data storage device.

FIG. 2 is an elevational diagrammatic illustration of a head relative to a disc.

FIG. 3 is a graphical illustration of fly height relative to spindle rotation speed (revolutions per minute—RPM) for a spindle motor.

FIG. 4 is a schematic illustration of an embodiment of a data storage device including spindle power control.

FIGS. 5-6 schematically illustrate embodiments of a data storage device including a landing zone for CSS and a glide zone for spindle power control.

FIG. 7 is a flow chart illustrating an embodiment of operation steps for a spindle power control embodiment.

### DETAILED DESCRIPTION OF ILLUSTRATIVE EMBODIMENTS

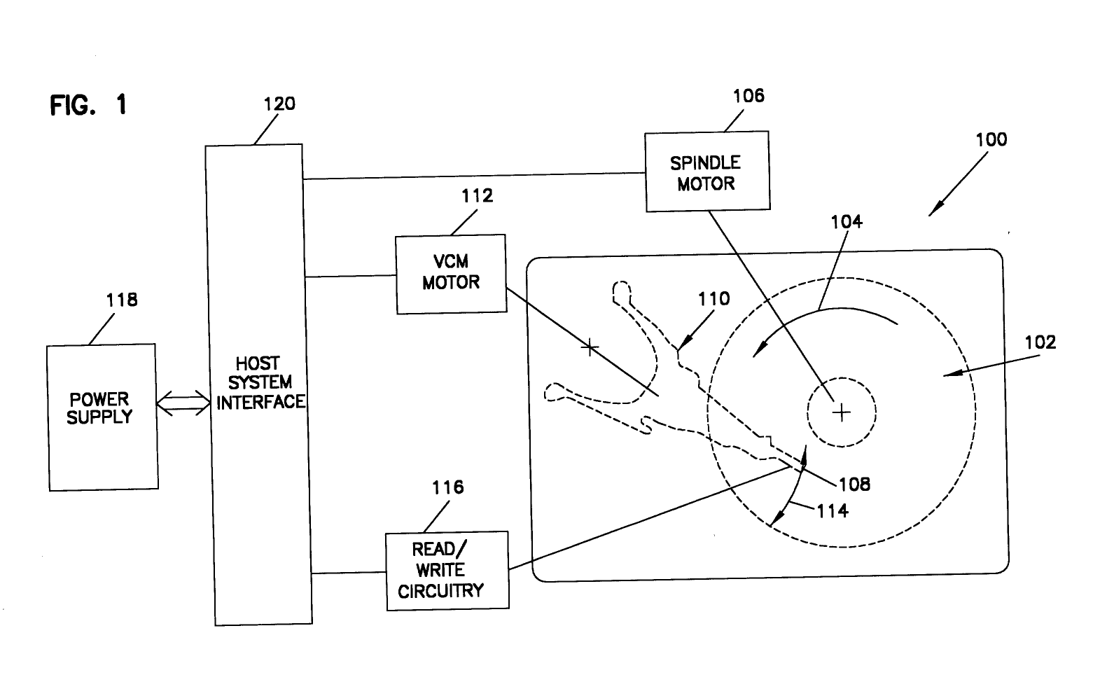

FIG. 1 is a diagrammatic illustration of a data storage device 100 in which embodiments of the present invention are useful. Data storage device 100 interfaces with a host system such a personal computer or a portable device to provide data storage. As shown, device 100 includes at least one discs 102 supported for rotation as illustrated by arrow 104 by a spindle motor 106 (illustrated schematically). Heads 108 are coupled to an actuator 110 which is powered by a voice coil motor 112 to provide an actuator assembly to position the head 108 relative to selected data tracks on the disc 102 as illustrated by arrow 114. The heads 108 include at least one transducer element coupled to read/write circuitry 116 illustrated schematically to read data from or write data to the disc 102. For example, transducer elements include inductive, magnetoresistive, tunneling magnetoresistive, or magneto-optical transducer elements. As illustrated, the spindle motor 106, voice coil motor 112 and read/write circuitry 116 are energized by a power source or supply 118 through a host system interface 120 as schematically shown.

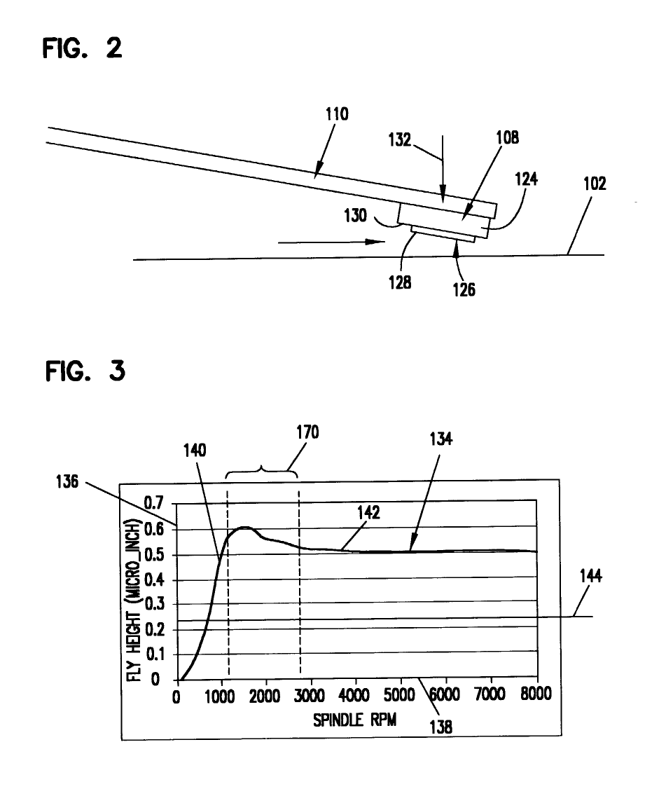

As illustrated in FIG. 2, for proximity or near proximity recording, heads 108 include a slider 124 which includes an air bearing surface 126 having a raised bearing surface 128 and a recessed bearing surface 130 illustrated diagrammatically. The slider 124 carries the transducer elements for read-write operations. Rotation of the disc 102, as illustrated by arrow 104 in FIG. 1, provides an air flow along the air bearing surface 126 of the slider 124 to provide a hydrodynamic lifting force which defines in part a fly height of the slider 124 in combination with a preload force to the slider provided by a suspension or load assembly as schematically illustrated by arrow 132. For operation, the disc 102 is rotated so that the fly height of the slider is above a glide avalanche height of the disc to limit head disc interface. The glide avalanche height of the disc is the height below which the head 108 will have massive contacts with the disc. It should be understood that sliders include different air bearing structures such as for example a slider having opposed bearing rails and a slider including opposed side rails and a center pad, and application of the present invention is not limited to any particular bearing design.

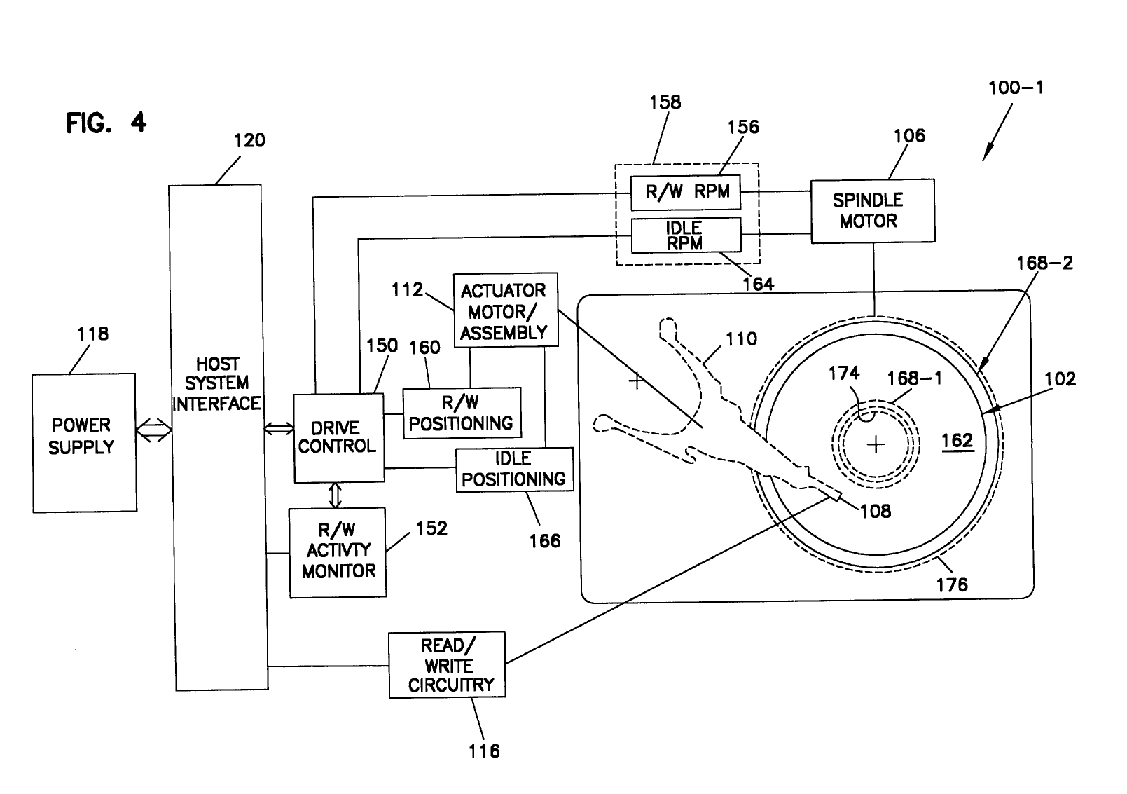

FIG. 3 graphically illustrates fly height 134 of the slider 124 as illustrated by axis 136 relative to spindle rotation speed of the spindle motor or spindle RPM as illustrated by axis 138. As shown in region 140 as the spindle rotation speed increases the fly height increases. The fly height increases to a steady state fly height 142 for the head-spindle assembly above a glide avalanche height 144 of the disc. For read-write operation, the spindle motor rotates the disc at a relatively high spindle rotation speed at a steady state fly height spindle speed for read/write operations and desired operating and processing speed. Operation or spindle rotation speed as shown may vary depending upon the parameters of the device. As previously described, operation of the spindle motor 106 at a full spindle RPM or spindle speed, increases power demands which can limit the operating time or use for remote or battery powered devices. Powering off the spindle motor can increase wear and can increase access or seek times following an idle period or interruption in read-write activity.

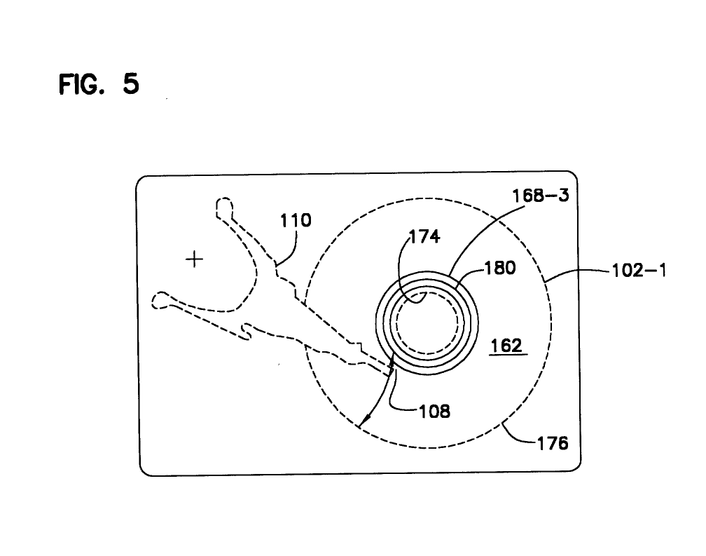

FIG. 4 schematically illustrates an embodiment of a data storage 100-1 device including spindle power control to reduce power consumption during an idle period where like numbers are used to identify like parts in the previous FIGS. As shown, operation of the spindle motor 106 and actuator motor 112 is coupled to a drive controller 150 illustrated schematically to energize the spindle motor 106 for rotation and the actuator motor 112 for head positioning. In the illustrated embodiment, the drive controller 150 receives feedback from a read-write (R-W) activity monitor or clock as illustrated by block 152 to provide multiple operating modes based upon read-write activity to reduce power consumption.

In the illustrated embodiment, in a read-write mode the drive controller 150 interfaces with a R-W control mode 156 of spindle control 158 to rotate the spindle motor 106 at a high RPM for read-write operations. The high RPM provides desired fly height and transducing speed for read-write operations. As schematically shown, a R-W position control 160 positions the head 100 relative to selected data tracks in a data zone 162 of the disc based upon a read/write command for read/write operation. In an idle mode, the drive controller 150 interfaces with an idle control mode 164 of spindle control 158 to rotate the spindle motor at a lower RPM than the high RPM for read-write operations to reduce power consumption and an idle position control 166 energizes the actuator motor 112 or assembly to position the head 108 in a dedicated glide zone (e.g. 168-1, 168-2).

The spindle motor is powered down during the idle mode or period to conserve power to reduce delay for read/write operations following an idle period. In particular, as illustrated with reference to FIG. 3, the spindle speed or RPM is reduced from a high spindle speed above a steady state fly height transition zone spindle speed 170 of the slider to a steady state fly height transition zone spindle speed 170. Thus, the spindle speed or RPM of the spindle motor is reduced to a spindle speed having a fly height above the glide avalanche height of the disc to reduce power consumption while maintaining the slider above the glide avalanche height of the disc. As described, the idle position control 166 moves the head to the dedicated glide zone 168 to limit interference or damage to the data zone 162 of the disc for idle power control.

As shown in FIG. 4, glide zone 168-1 is proximate to an inner diameter 174 of the disc in one embodiment or alternatively glide zone 168-2 is proximate to an outer diameter 176 of the disc in another embodiment. The position or location of the glide zone 168 is designed based upon power, speed or fly height parameters of the data storage device. For example, the linear speed of the disc is higher proximate to the outer diameter 176 relative to the inner diameter 174 of the disc so that locating the glide zone 168 at the outer diameter 176 may enhance flyability at lower RPMs and may reduce power consumption and spindle RPM parameters. Alternatively positioning the glide zone 168 proximate to the outer diameter 176 requires a greater loss of data area as compared to data loss by positioning the glide zone 168 at the inner diameter 174.

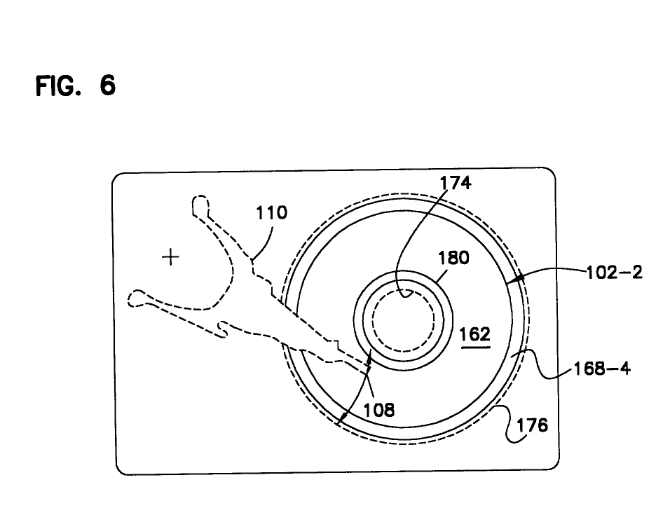

In one embodiment, glide zone 168 includes a relatively low roughness average or height to limit head disc interface. For a CSS, the disc includes a dedicated landing zone so that the slider interfaces with the disc surface on the landing zone when the spindle motor is powered off. In one embodiment, illustrated in FIG. 5, disc 102-1 includes a glide zone 168-3 proximate to the inner diameter 174 adjacent to landing zone 180 and in another embodiment shown in FIG. 6, the glide zone 168-4 is positioned proximate to the outer diameter 176 spaced from the landing zone 180 at the inner diameter 174 of the disc 102-2. Alternatively, the slider 124 can include plurality of landing or contact pads on the air bearing surface to provide stiction control for CSS for a relatively smooth media or landing zone and the dedicated glide zone 168 is on the landing zone 180 for CSS. In an embodiment of a ramp load/unload device, the glide zone 168 is positioned proximate to a ramp loading/unloading area at the outer diameter 176 of the disc. Thus, during idle periods, the head flies above the disc surface in the glide zone and does not have to be retracted reducing ramp wear and damage to the disc.

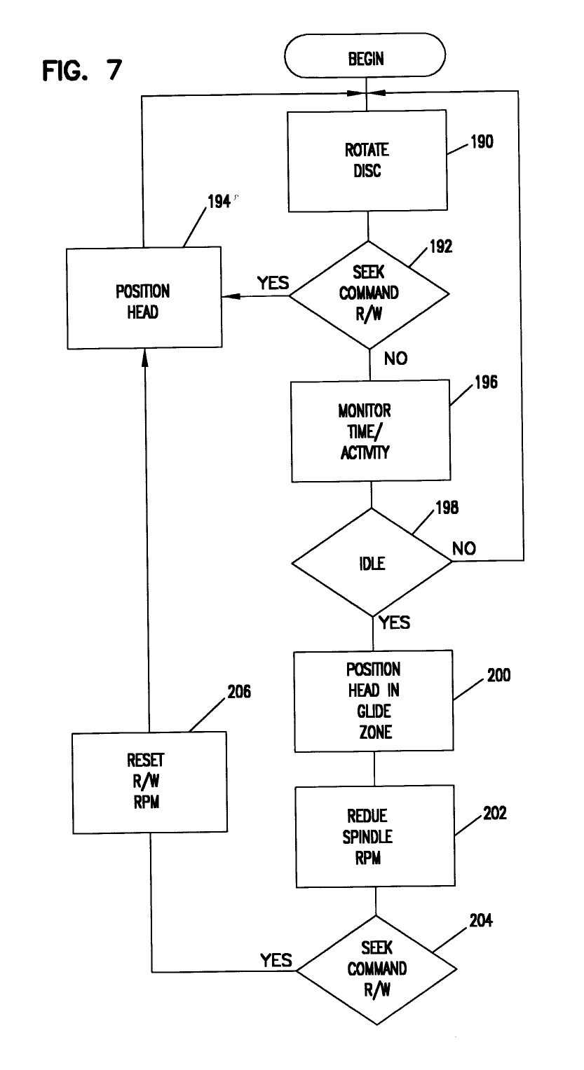

FIG. 7 illustrates a flow chart for an operation embodiment of spindle power control. As shown, disc 102 is rotated as illustrated by block 190 and the head is positioned relative to selected data tracks to execute a seek or read/write command as illustrated by blocks 192, 194. Read/write activity is monitored as illustrated by block 196 to detect an idle period as illustrated by block 198. During an idle period, the head is positioned in the glide zone as illustrated by block 200 and the spindle RPM or speed is reduced as illustrated by block 202. Following the idle period as illustrated by block 204, the spindle speed is increased to the full read-write spindle speed or RPM as illustrated by block 206 and the head is positioned relative to selected data tracks for read/write operations as illustrated by block 194.

A data storage device including spindle power control to reduce power consumption. The spindle power control includes read-write control mode (such as 156) and an idle control mode (such as 164). In the read-write control mode, the spindle motor (such as 106) is energized to rotate a disc (such as 102) at a full operating speed for read-write operations and in the idle control mode, spindle rotation is reduced to provide an idle power mode. The idle power mode provides a desired or steady state fly height spindle speed and the head glides or flies above the disc surface to reduce power consumption.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application while maintaining substantially the same functionality without departing from the scope and spirit of the present invention. In addition, although the embodiments described herein are directed to an illustrated data storage device it will be appreciated by those skilled in the art that the teachings of the present invention can be applied to other devices without departing from the scope and spirit of the present invention.

What is claimed is:

1. A data storage device comprising:
at least one disc coupled to a spindle motor to rotate the at least one disc and the at least one disc including a data zone and a glide zone;
a head coupled to an actuator assembly operable to position the head relative to the at least one disc for operation;
spindle control coupled to the spindle motor having a read-write control mode and an idle control mode and the idle control mode energizing the spindle motor to rotate the spindle motor at a lower spindle speed than the read-write control mode; and
position control coupled to the actuator assembly including a read-write position control and an idle position control where the read-write position control positions the head relative to selected data tracks in the data zone of the disc and the idle position control positions the head in the glide zone during an idle mode.

2. The data storage device of claim 1 wherein the spindle control operates the spindle motor in the idle control mode based upon feedback from a readwrite activity monitor.

3. The data storage device of claim 1 wherein the at least one disc includes an inner diameter and an outer diameter and the glide zone is proximate to the inner diameter.

4. The data storage device of claim 1 wherein the at least one disc includes an inner diameter and an outer diameter and the glide zone is proximate to the outer diameter.

5. The data storage device of claim 1 wherein idle control mode rotates the spindle motor at a steady state fly height transition zone spindle speed.

6. The data storage device of claim 1 wherein the disc includes a landing zone for contact starts and stops and the glide zone is in the landing zone.

7. The data storage device of claim 1 wherein the disc includes a landing zone for contact starts and stops and the glide zone is separate from the landing zone.

8. A data storage device comprising:
at least one disc coupled to a spindle motor to rotate the at least one disc;
a head coupled to an actuator assembly operable to position the head relative to the at least one disc for operation;
a read-write activity monitor to monitor read-write activity to detect an idle mode; and
spindle control coupled to the read-write activity monitor having a readwrite control mode and an idle control mode and the idle control mode energizing the spindle motor to rotate the spindle motor at a lower spindle speed than the read-write control mode and at a steady state fly height transition zone spindle speed.

9. The data storage device of claim 8 and comprising:
idle position control coupled to the actuator assembly to position the head in a dedicated glide zone during the idle mode.

10. A data storage device comprising:
at least one disc coupled to a spindle motor to rotate the at least one disc for operation and a head coupled to an actuator assembly operable to position the head relative to the at least one disc for operation; and
spindle power control having an idle control means for reducing spindle motor rotation speed to reduce power consumption during an idle period.

11. The data storage device of claim 10 wherein the idle control means provides a steady state fly height spindle speed during the idle period between contact starts and stops.

12. The data storage device of claim 10 wherein the idle control means includes idle position control to position the head in a glide zone.

13. A method for operating a data storage device, comprising steps of:
powering a spindle motor to rotate at least one disc in a read-write control mode; and
energizing an actuator assembly having a head coupled thereto to move the head to a dedicated glide zone and reducing spindle speed of the spindle motor during an idle period.

14. The method of claim 13 and further comprising the step of:
monitoring read-write activity to provide feedback to reduce the spindle speed and energize the actuator assembly to move the head to the glide zone in the idle period.

15. The method of claim 13 and further comprising the step of increasing the spindle speed following the idle period.
